(19) United States
(12) Patent Application Publication
(10) Pub. No.: US 2024/0313860 A1
(43) Pub. Date: Sep. 19, 2024

(54) Nibble Bus

(71) Applicants: Del Wolverton, Santa Rosa, CA (US); Gary Neal Poovey, Dunsmuir, CA (US)

(72) Inventors: Del Wolverton, Santa Rosa, CA (US); Gary Neal Poovey, Dunsmuir, CA (US)

(21) Appl. No.: 18/209,150

(22) Filed: Jun. 13, 2023

Related U.S. Application Data
(60) Provisional application No. 63/473,992, filed on Dec. 16, 2022.

(51) Int. Cl. H04B 10/278

(52) U.S. Cl. CPC H04B 10/278

(57) ABSTRACT

The NIBLE BUS is an all-optical broker of signals for managing data. Data transfer from one computer system to another requires close management of data content, origin, and destination. A system of data switches, steering components, and buffer memories used to accomplish this function. The NIBLE BUS accomplishes this brokering of signals using only light signals.

### PRIOR ART

U.S. Pat. No. 10,621,120 B2 issued to Ian P Shaffer, Arun Vaidyanath, and Sanku Mukherjee which teaches BUFFER COMPONENT FOR ASYMMETRIC-CHANNEL MEMORY SYSTEM

U.S. Pat. No. 10,838,816 B2 issued to Jesse P. Arroyo, Ellen M. Bauman, Timothy R. Block, and Christopher J. Engel which teaches DETECTING AND SPARING OF OPTICAL PCIE CABLE CHANNEL ATTACHED IO DRAWER.

### BACKGROUND OF THE INVENTION

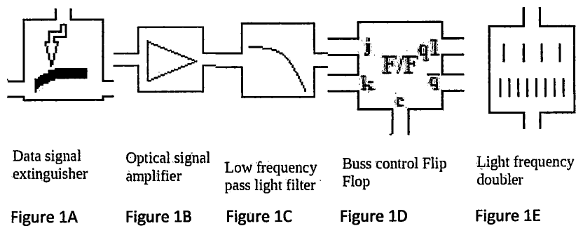

Data transfer from one computer system to another requires close management of data content, origin, and destination. A system of data switches, steering components, and buffer memories used to accomplish this function. U.S. Pat. No. 10,621,120 B2 issued to Ian P Shaffer, Arun Vaidyanath, and Sanku Mukherjee which teaches BUFFER COMPONENT FOR ASYMMETRIC-CHANNEL MEMORY SYSTEM is such a system for managing data transfer considerations. Mr. Shaffer's FIG. 1 has labeled at the top “Memory Module Sockets (215).” Also seen on his FIG. 1, is “I/O Steering 205” which directs the data into the four memory sockets. In column 11 lines 35 and 36 Mr. Shaffer's patent states that a voltage switches on a pass gate 383. Mr. Shaffer's system is not fiber optic using only light. In column 14 line 67 and in column 15 line 20, optical storage media is mentioned in U.S. Pat. No. 10,621,120 B2, but the functioning of the data management is described in completely electrical terms.

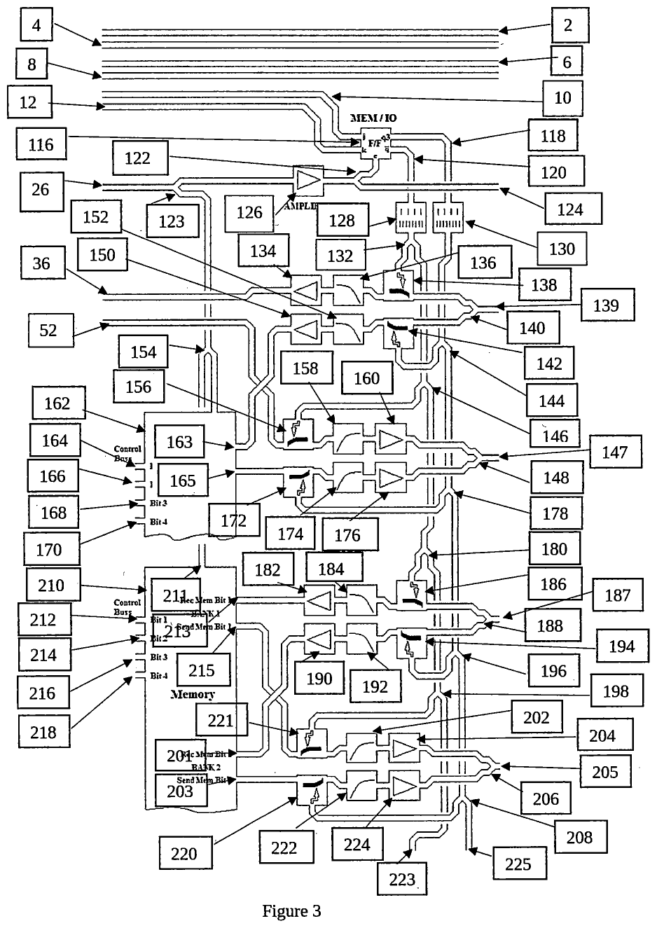

A further example of prior art is seen in Unites States U.S. Pat. No. 10,838,816 B2 issued to Jesse P. Arroyo, Ellen M. Bauman, Timothy R. Block, and Christopher J. Engel which teaches DETECTING AND SPARING OF OPTICAL PCIE CABLE CHANNEL ATTACHED IO DRAWER. Mr. Arroyo refers to optical channels in column 5 line 2 of this patent. Clearly, this patent involves optical signals. In FIG. 1, feature 144 is called “optical cables” in column 5 lines 12 and 13. Mr. Arroyo's patent involves both optical and electrical signals as is shown in column 5 line 19 referring to DC signals. In FIG. 3B, feature 370 is a flash memory in U.S. Pat. No. 10,838,816 B2.

### SUMMARY OF THE INVENTION

The NIBBLE BUS is all optical data transfer device that uses only optical signals instead of electrical signals. Optical signals come into the NIBBLE BUS and are managed by all optical devices into all optical memory from which the data is redirected to the desired receiving computer or communication device or system. The advantage of this new art being all optical is the speed of functioning. Electrical circuits, switches, and transistors function in nanoseconds (10E-9 seconds) because the electrons drift through matter drive by electrical fields. Light travels at the speed of light and fiber optic circuits, switches, and devices function in picoseconds (10E-12 seconds). The speed with which the NIBBLE BUS handles and transfers the data or communication is hundreds of times faster than previous technologies.

The BUFFER COMPONENT FOR ASYMMETRIC-CHANNEL MEMORY SYSTEM of Mr. Shaffer mentions that a voltage switches gate 383 for his device. Because it is a voltage, the gate switches in the nanosecond speed realm not the picosecond realm hundreds of times slower than the NIBBLE BUS technology. Mr. Shaffer's device stores data in memory and systematically brokers the data out as does the NIBBLE BUS.

The patent for DETECTING AND SPARING OF OPTICAL PCIE CABLE CHANNEL ATTACHED IO DRAWER of Mr. Arroyo tell so a DC signals. DC signals are electrical. Electrical circuits, switches, and transistors function in nanoseconds (10E-9 seconds) because the electrons drift through matter drive by electrical fields. Light travels at the speed of light and fiber optic circuits, switches, and devices function in picoseconds (10E-12 seconds). The speed with which the NIBBLE BUS handles and transfers the data or communication is hundreds of times faster than previous technologies. Mr. Arroyo's invention includes memory for storing data before it is sent out. Mr. Arroyo's invention includes optical cables as well.

The NIBBLE BUS takes in 13 lines of optical data brokering the data into four memories. The preferred embodiment of this new art is all optical memory. In an alternative embodiment one or all of the memory devices may be flash drive or complementary metal oxide silicon (CMOS) memory. From these memories the data is brokered out to computer or communication devices through four optical fibers or optical channels on a computer chip substrate. The NIBBLE BUS can receive and broker the data back out 100 times faster than previous technology because the NIBBLE BUS is all optical.

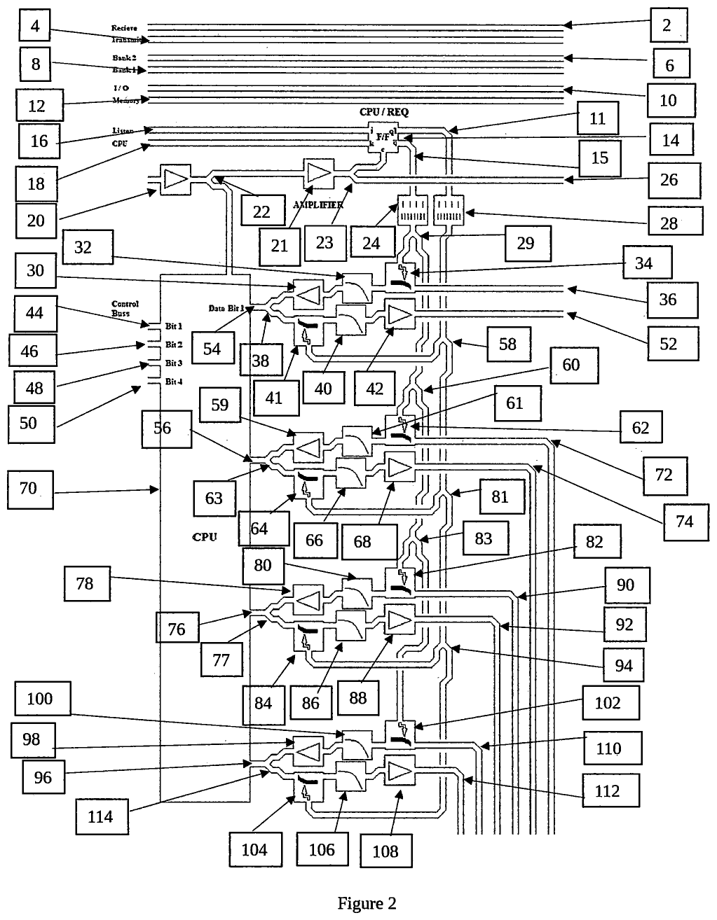

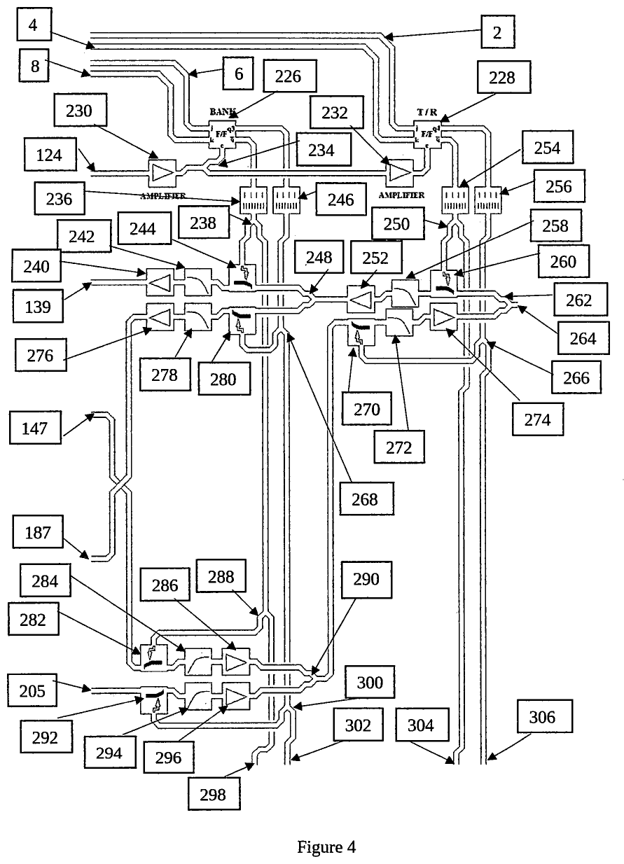

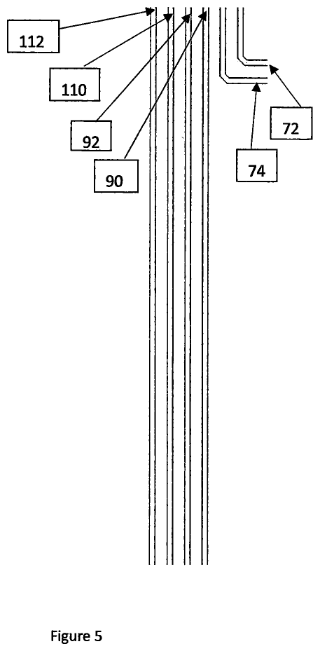

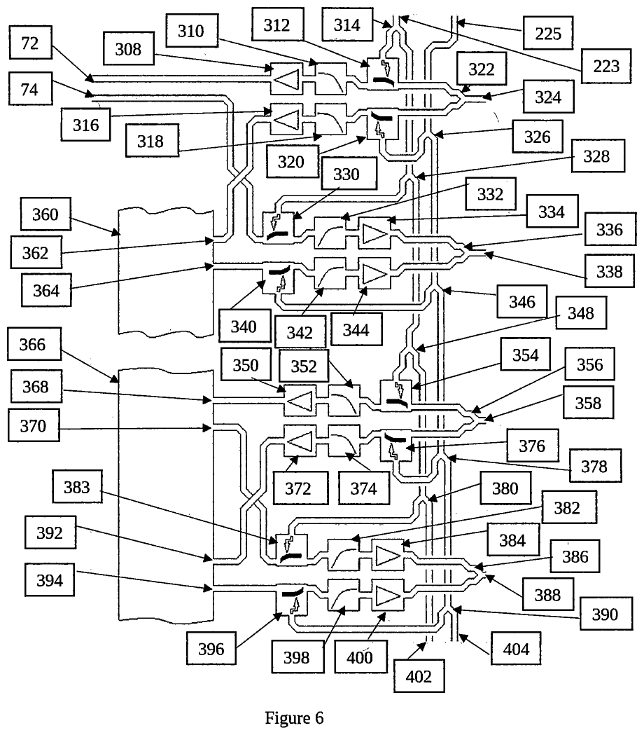

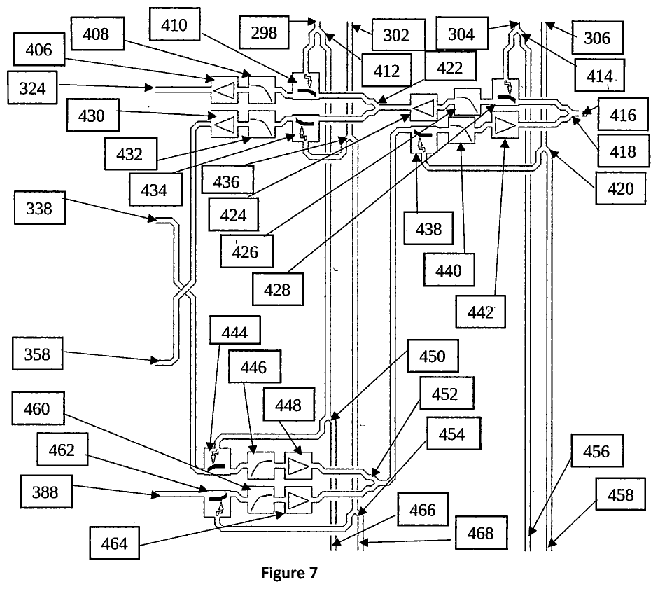

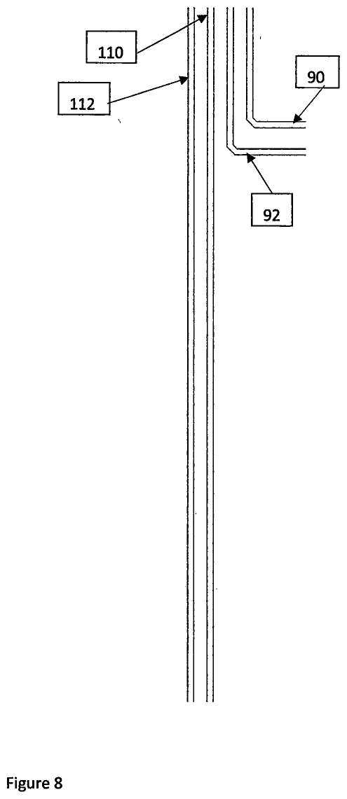

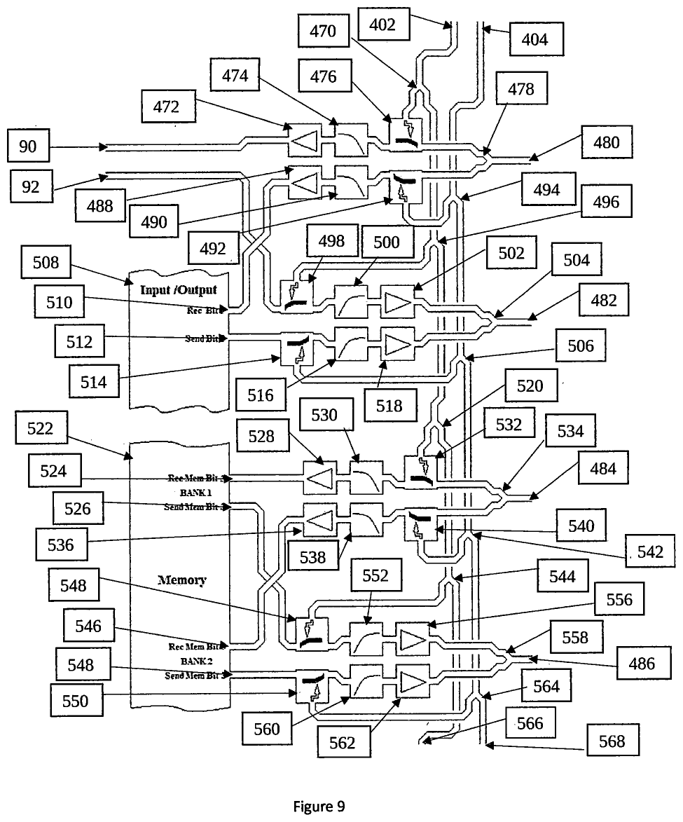

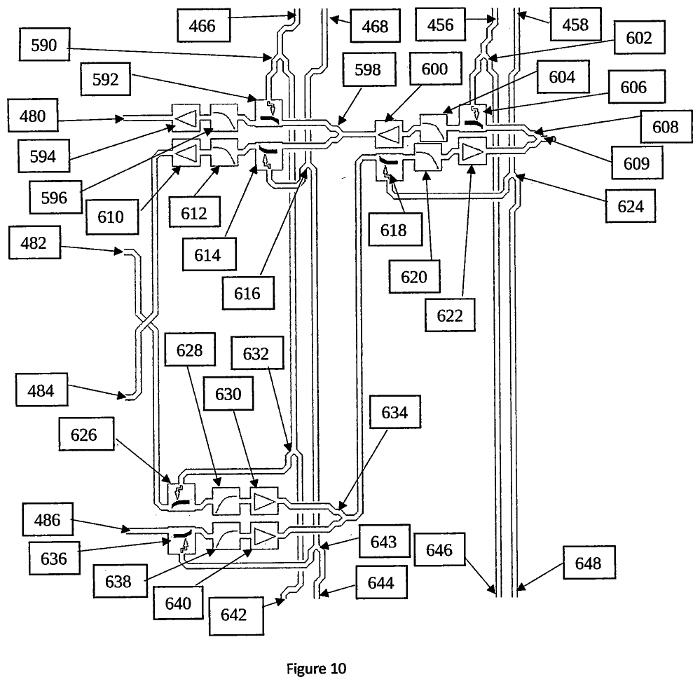

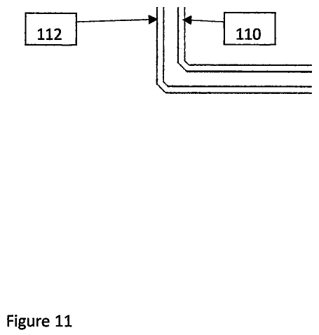

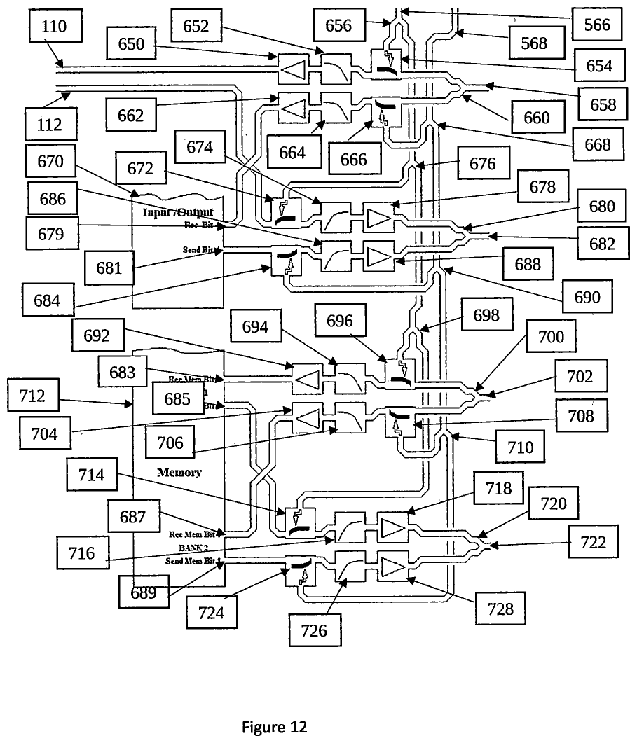

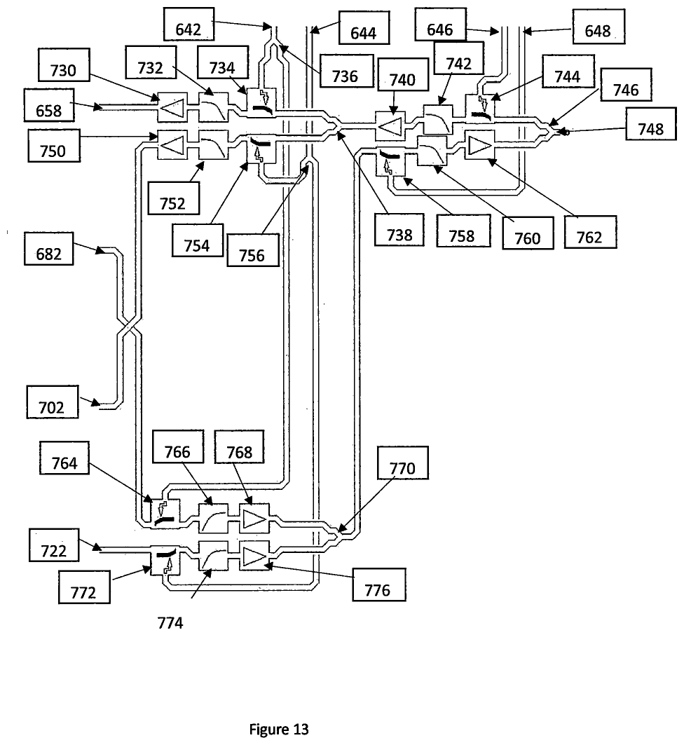

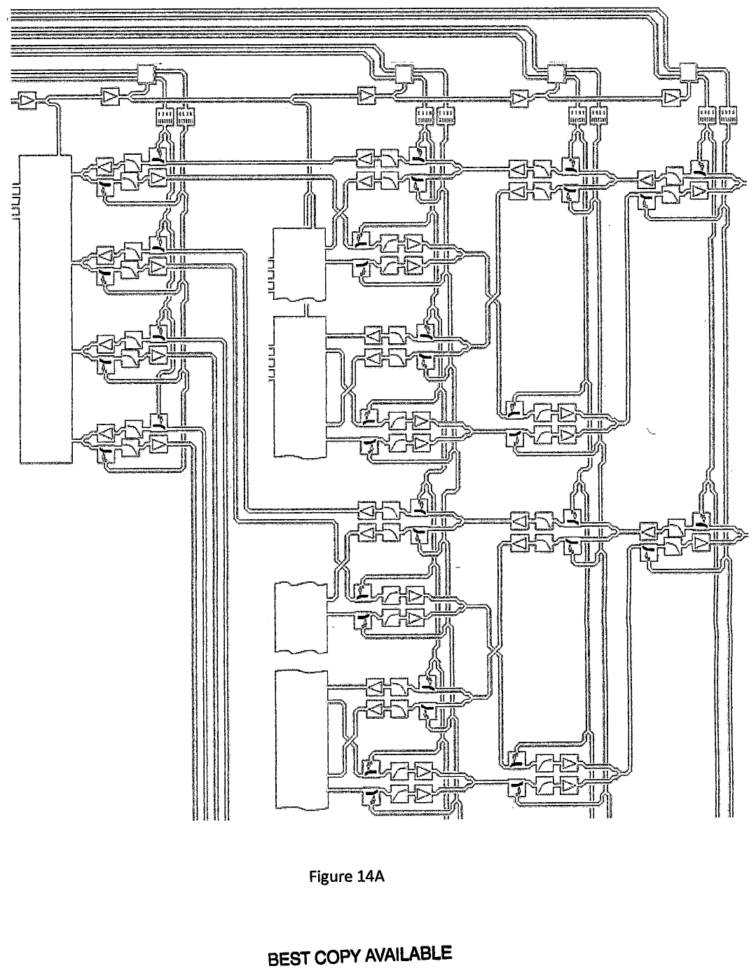

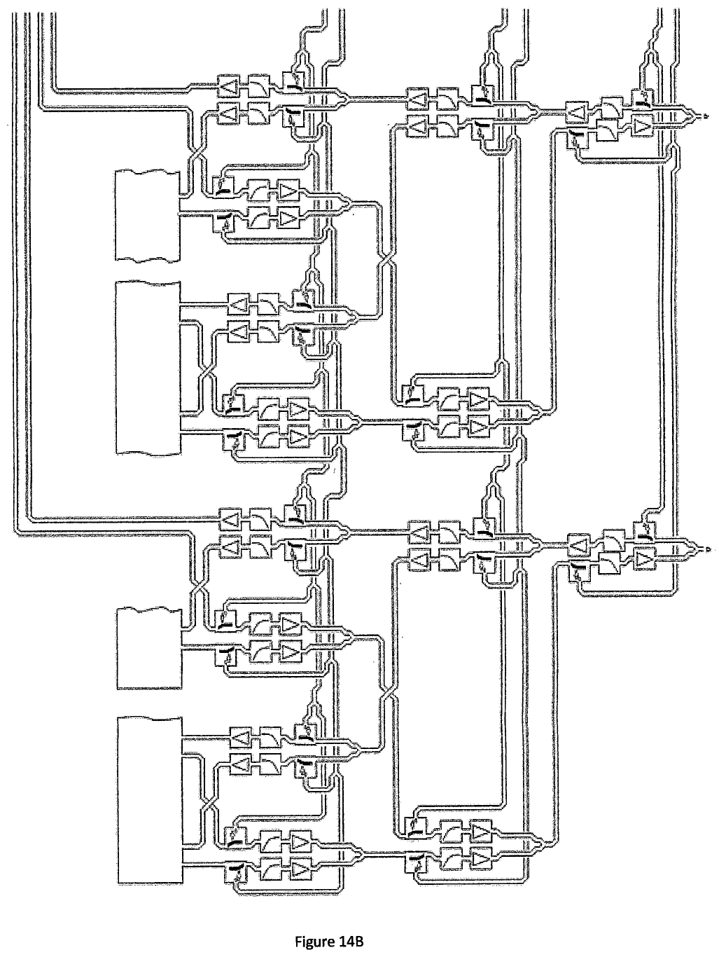

### BRIEF DESCRIPTION OF DRAWINGS

| | |
|---|---|
| FIG. 1A | Data signal extinguisher |
| FIG. 1B | Optical signal amplifier |
| FIG. 1C | Low frequency pass light filter |
| FIG. 1D | BUS control Flip Flop |
| FIG. 1E | Light frequency doubler |
| FIG. 2 | Input section of bus |
| FIG. 3 | First memory |
| FIG. 4 | First output |
| FIG. 5 | Light channels to lower bus |
| FIG. 6 | Second memory |
| FIG. 7 | Second output |
| FIG. 8 | Light channels to bus bottom |
| FIG. 9 | Third memory |
| FIG. 10 | Third output |
| FIG. 11 | Light channels to bottom memory |
| FIG. 12 | Fourth memory |
| FIG. 13 | Fourth output |
| FIG. 14 | System architecture diagram (FIG. 14A, 14B) |

### DETAILED DESCRIPTION OF THE INVENTION

The NIBBLE BUS runs on light signals. All the components of the NIBBLE BUS are to be light only devices. The speed with which the NIBBLE BUS fosters communication between a computer or communication system is the speed of light. Electrical signals emanating from the NIBBLE BUS are eliminated. Higher levels of secure communication are fostered by the all-optical nature of the NIBBLE BUS.

FIG. 1A pictures the data signal extinguisher device. The data signal extinguisher turns off data light by the application of a second light signal. When the second light signal is not applied, the data light is turned on. The data light is usually a wavelength around 1560 nm in length. The second light signal is called the switching light and usually will have a wavelength of around 780 nm. These wavelengths allow data light to be turned into switching light using a frequency doubling crystal.

The second optical device is pictured in FIG. 1B. This second device is an optical signal amplifier. In fiber optic communication lines across long distance, amplifiers like this are used to boost signal strength. They are laser like in function. The material of the amplifier has pumped atoms that lase in the frequency of the data signal adding energy to the data signal.

A low frequency pass light filter is the component pictured in FIG. 1C. This component filters out the higher frequency switching light, while allowing the data signal light to pass through. This prevents the switching light from actuating data signal eliminators on down the light fiber. This component can be constructed using an infrared adsorbing die.

FIG. 1D is an all-optical bus control flip flop. A light signal enters j or k and that signal is distributed to q1 or q̅ and maintained until the c signal resets the flip flop. The q1 or q̅ signal goes on to switching devices that control the flow of data in the NIBBLE BUS.

A light frequency doubler is seen in FIG. 1E. Chemicals in this part of the light channel cause light of one frequency to double to light of twice the frequency. These chemicals may be studied referring to U.S. Pat. No. 4,876,688 which teaches FREQUENCY DOUBLING CRYSTALS, published Oct. 24, 1989. Which is here incorporated by reference. Francis Wang and Stephan P. Velsko provided this research and patent to allow new frequencies of higher frequency light. This frequency doubling allows the data light managed by the NIBBLE BUS to be converted into switching light for information flow control.

The main body of light channels used for the function of the NIBBLE BUS. The full presentation of the NIBBLE BUS working is displayed in the next 12 FIGS. 2 through 13. In FIG. 2, it will be noticed that central processing unit number 70 has four control bus inputs on the left numbered 44, 46, 48, and 50. Central processing unit 70 receives input from 44, 46, 48, and 50, and returns data to the NIBBLE BUS through 54, 56, 76, and 96. While 44, 46, 48, and 50 are control inputs, 54, 56, 76, and 96 may produce output data and be a means for data from the NIBBLE BUS back into the central processing unit interface. In an alternative embodiment, one, two, or three input channels can be processed by the NIBBLE BUS. In an alternative embodiment, NIBBLE BUS assemblies can be grouped together to handle four, twelve, sixteen, or more multiples of four input signals. In a further alternative embodiment, the NIBBLE BUS assemblies can be grouped to manage any number of input channels from one, two, three, four, five, six, seven, or any number of input channels.

Optical channel numbered 2 brings in signals that require information to be received by the NIBBLE BUS. Light channel numbered 4 brings in signals that require information to be transmitted out of the NIBBLE BUS. Light channel 6 brings in signals that specify data to be stored in optical memory bank two. While optical channel 8, brings in signals that specify data to be stored in optical memory bank one.

Optical channel number 10 specifies that signals will be sent into the input/output chip which will be numbered 162 in FIG. 3, 360 in FIG. 6, 508 in FIG. 9, and 670 in FIG. 12. Light channel 12 specifies that a data signal will be sent to an optical memory bank which will be numbered 210 in FIG. 3, 366 in FIG. 6, 522 in FIG. 9, and 712 in FIG. 12. Optical channel 16 brings in signals that tell the NIBBLE BUS to listen and receive data. Optical channel 18 tells the NIBBLE BUS to send information to said central processing unit interface. Component 20 amplifies a clock signal for the NIBBLE BUS. Optical channel feature 22 splits the output of amplifier 20 to send signals to said central processing unit interface 70 and on to optical amplifier 21. Feature 23 is splitting the light signal into two paths. One provides a control signal into flip flop 14, and the other goes on to optical channel 26 to provide a clock control signal to more of the NIBBLE BUS.

Optical channel 11 brings a signal out of flip flop 14 that brings signals out of 54 to the rest of the NIBBLE BUS through optical channel 52. Light channel 15 brings a signal out of flip flop 14 that brings signals into said central processing unit interface 70 from optical channel 36. This process is facilitated by frequency doubler 24. Frequency doubler 24 changes the data signal from flip flop 14 into a switching signal to regulate data coming into said central processing unit interface 70. In like manner frequency doubler 28 changes the data signal from flip flop 14 into a switching signal that regulates data signals coming out of said central processing unit interface to optical channel 52. Optical channel 15 to data light extinguishers 34, 62, 82, and 102 has unpictured optical signal amplifiers that boost the signal divided by dividers 29, 60, and 83 back up to full strength.

Optical channel 15 in concert with data signal extinguisher 34, low frequency pass filter 32 and optical amplifier 30 use the optical signal from flip flop 14 to control optical signals coming from optical channel 36 into said central processing unit 70. Optical channel 11 to data signal eliminators 41, 64, 84, and 104 has unpictured optical signal amplifiers that boost the signal divided by signal dividers 58, 81, and 94 back up to full strength.

Optical channel 11 in concert whit data signal extinguisher 41, low frequency pass filter 40, and optical amplifier 42 use the optical signal from flip flop 14 to control data signals going out of said central processing unit interface 70 to the NIBBLE BUS by way of optical channel 52. Optical signal divider 38 brings data in from optical amplifier 30 to said central processing unit interface 70, and signal divider 38 takes data out of said central processing unit to data signal extinguisher 41.

Data port 56 to said central processing unit 70 is provided a path for data to go out and data that comes in from signal divider 63. A signal from flip flop 14 bring data into said central processing unit interface 70 through optical channel 15 into data extinguisher 62 from optical channel 72. Data extinguisher 62 feeds data to low pass filter 61 and on to optical amplifier 59 into input 56. Flip flop 14 sends a signal through light channel 11 to send data out from data port 56 to data extinguisher 64. Data extinguisher 64 feeds low pass filter 66. Low pass filter 66 feeds optical amplifier 68 that sends data out through optical channel 74.

Data port 76 to said central processing unit interface 70 is provided a path for data to go out and data that comes in from splitter 77. A signal from flip flop 14 bring data into said central processing unit interface 70 through optical channel 15 into data extinguisher 82 from optical channel 90. Data extinguisher 82 feeds data to low pass filter 80 and on to optical amplifier 78 into input 76. Flip flop 14 sends a signal through light channel 11 to send data out from data port 76 to data extinguisher 84. Data extinguisher 84 feeds low pass filter 86. Low pass filter 86 feeds optical amplifier 88 that sends data out through optical channel 92.

Data port 96 to said central processing unit interface 70 is provided a path for data to go out and data that comes in from signal divider 114. A signal from flip flop 14 bring data into said central processing unit interface 70 through optical channel 15 into data extinguisher 102 from optical channel 110. Data extinguisher 102 feeds data to low pass filter 100 and on to optical amplifier 98 into input 96. Flip flop 14 sends a signal through optical channel 11 to send data out from data port 96 to data extinguisher 104. Data extinguisher 104 feeds low pass filter 106. Low pass filter 106 feeds optical amplifier 108 that sends data out through optical channel 112.

At the top of FIG. 3 optical channel numbered 2 brings in signals that require information to be received by the NIBBLE BUS. Optical channel numbered 4 brings in signals that require information to be transmitted out of the NIBBLE BUS. Optical channel 6 brings in signals that specify data to be stored in optical memory bank two. While optical channel 8, brings in signals that specify data to be stored in optical memory bank one.

Optical channel number 10 specifies that signals will be sent into the input/output chip 162 by flip flop 116. The input/output chip is number 162 in FIG. 3. Optical channel 12 specifies that data signals will be sent into optical memory bank by flip flop 116. The optical memory bank is number 210 in FIG. 3. The input/output chip 162 receives control bus inputs from 164, 166, 168, and 170. The optical memory chip receives control bus inputs from 212, 214, 216, and 218. Said clock control signal is provided by optical channel 26 provides the clock control signal to signal divider 123 that sends a signal to the input/output chip 162 and via divider 154 to the optical memory chip on one side and to optical amplifier 126 on the other. Optical amplifier 126 provides the clock signal to flip flop 116 through one side of signal divider 122 and on to optical amplifier 230 in FIG. 4 through optical channel 124 on the other.

From flip flop 116 a signal on optical channel 118 to frequency doubler 130 and on to data signal extinguisher 142 to direct data via signal divider 144 into input/output chip 162. From flip flop 116 a signal on light channel 120 to frequency doubler 128 through signal divider 132 to data signal extinguisher 138 to direct data into said central processing unit 70 via optical channel 36. Signals from data signal extinguisher 138 are directed to low pass filter 136 on to optical amplifier 134 to optical channel 36. Signals from data signal extinguisher 142 are directed to low pass filter 152 on to optical amplifier 150 to input/output chip 162 by receive port 163. Signal divider 140 brings signals from the outside world vial optical channel 139 into the input/output chip or said central processing unit 70. Signal divider 140 also brings together data signals from said central processing unit interface 70 and said input/output chip 162 to go out to the outside world via light channel 139.

Signal divider 154 receives said clock signal from signal divider 123 and sends clock signals to said input/output chip 162 and said memory chip 210. Optical channel from signal divider 132 to signal divider 146 to signal divider 180 to signal divider 198 has unpictured optical signal amplifiers. Light channel from signal divider 144 to signal divider 178 to signal divider 196 to signal divider 208 has unpictured optical signal amplifiers.

Data signals from optical channel 52 are directed via data signal eliminator 156 and low pass filter 158 and optical amplifier 160 and signal divider 148 to optical channel 147. Input/output chip 162 data signals go out from data port 165 to data signal eliminator 172 to low pass filter 174 to optical amplifier 176 to signal divider 148 to optical channel 147.

Memory chip 210 has control inputs 212, 214, 216, and 218, and memory chip 210 has a clock signal input 211. Said memory chip 210 has inputs 213 of memory one and 201 of memory two by outputs 215 and 203. From optical channel 187 through signal divider 188, data signal eliminator 186 sends signals on to low pass filter 184 to optical amplifier 182 to optical memory chip 210. Signal divider 188 also sends signals to data signal eliminator 194 to low pass filter 192 to optical amplifier 190 to optical memory input 201.

Memory chip 210 sends information out through data port 215 from optical memory one to data signal eliminator 221 to low pass filter 202 to optical amplifier 204 to signal divider 206 to optical channel 205. Optical memory chip 210 sends information out through data port 203 of memory two to data signal eliminator 220 to low pass filter 222 to optical amplifier 224 to signal divider 206 to optical channel 205. Optical channels 223 and 225 send signals to control the input/output and optical memory chips.

FIG. 4 pictures optical channels 2 and 4 to flip flop 228 which controls transmit and receive functions of the NIBBLE BUS. Optical channels 6 and 8 feed flip flop 226 which controls input to optical memory bank one or optical memory bank two. Light channel 124 feeds optical amplifier 230 to bring said clock signal to flip flop 226 and through signal divider 234 to optical amplifier 232 to flip flop 228. Flip flop 226 sends a signal to frequency doubler 236 through signal divider 238 to data signal eliminator 244 to send signals from NIBLE BUS output port 264 through signal divider 248 to low pass filter 242 and optical amplifier 240 to optical channel 139 to said central processing unit 70. Flip flop 238 sends a signal from frequency doubler 246 to signal divider 268 to data signal eliminator 280 to low pass filter 278 to optical amplifier 276 to optical channel 187 to said optical memory chip.

Flip flop 226 sends a signal to frequency doubler 236 through signal divider 238 on to signal divider 288 and to data signal eliminator 282 to bring signals from said input/output chip by optical channel 147 to output port 264. Said flip flop 226 signal goes to low pass filter 284 to optical amplifier 286 to signal divider 290 to data eliminator 270. From data eliminator 270 to low pass filter 272 to optical amplifier 274 to signal divider 262 to output port 264. Said flip flop 226 signal is divided by signal divider 288 to go to optical channel 298 to go to FIG. 7 to control light to come in and go out of exit port 416.

Flip flop 226 signal from frequency doubler 246 to signal divider 268 and 300 to data signal eliminator 292 manages signals from said memory chip 210 from light channel 205. Said flip flop 226 signal from data signal eliminator 292 goes to low pass filter 294 to optical amplifier 296 through signal divider 290 to data signal eliminator 270 feeding output port 264. Flip flop 226 sends a signal to frequency doubler 246 to signal divider 268 and 300 on to optical channel 302 on to FIG. 7 to control signals to and from said optical memory chip.

Flip flop 228 sends a transmit or receive signal to frequency doubler 254 to signal divider 250 to dita signal eliminator 260 to low pass filter 258 to optical amplifier 252 to said central processing unit interface 70 and said input/output chip 162 in FIG. 3 via optical channel 139. Flip flop 228 sends a transmit or receive signal to frequency doubler 256 and on to signal divider 266 to data signal eliminator 270. Said signal leaves data signal eliminator 270 to go into low pass filter 272 to optical amplifier 274 and signal divider 262 to output port 264. Flip flop 228 sends a transmit or receive signal to frequency doubler 256 and to signal divider 266 on to optical channel 306 of FIG. 7 to provide transmit and receive signals. Flip flop 228 sends a transmit or receive signal to frequency doubler 254 and to signal divider 250 on to optical channel 304 to provide transmit or receive signals to FIG. 7 components.

FIG. 5 shows optical channels 72 and 74 going into the components shown in FIG. 6. FIG. 5 shows light channels 90, 92, 110, and 112 going into FIG. 8.

Light channel from 223 FIG. 3 brings a signal from flip flop 116 to signal divider 314 to data signal eliminator 312 to low pass filter 310 to optical amplifier 308 to provide light channel 72 signal to go into FIG. 5 and to said central processing unit port 56. Flip flop 116 signal goes from signal divider 314 to signal divider 328 to data signal eliminator 330 of control data from said central processing unit from light channel 74 from FIG. 5. Light signals from data signal eliminator 330 from optical channel 74 go to low pass filter 332 to optical amplifier 334 to signal divider 336 to optical channel 338 to FIG. 7 ultimately to exit port 416. Signals from exit port 416 in FIG. 7 enter FIG. 6 in light channel 324 and signal divider 322 to be go out to said central processing unit interface through optical channel 72 or to said input/output chip 360.

Flip flop 116 sends a signal to optical channel 225 to signal divider 326 to data signal eliminator 320 to low pass filter 318 to optical amplifier 316 into said input/output chip 360 by port 362. Flip flop 116 sends a signal to optical channel 225 to signal divider 346 to data signal eliminator 340. Said signal from signal divider 346 that goes to data signal eliminator 340 to low pass filter 342 to optical amplifier 344 sends signals from said input/output chip 360 port 364 to optical channel 338 to FIG. 7 and out exit port 416.

Flip flop 116 sends a signal from optical channel 223 through signal divider 328 to signal divider 348 to data signal eliminator 354 to low pass filter 352 to optical amplifier 350 to memory chip 366 port 368 for memory one. Data signal eliminator 354 brings signals from signal divider 356 which supplies signals from FIG. 7 via optical channel 358. Flip flop 116 sends a signal from optical cannel 223 through signal divider 328 to signal divider 348 to signal divider 380 to data signal eliminator 383 taking data from optical memory chip 366 from port 370. Said signal from data signal eliminator 383 goes to low pass filter 382 to optical amplifier 384 to signal divider 386 to light channel 388 out to FIG. 7.

Flip flop 116 sends a signal via optical channel 255 to signal divider 326 and on to signal divider 346 and on to signal divider 378. Said signal coming to signal divider 378 goes to data signal eliminator 376 to low pass filter 374 to optical amplifier 372 into optical memory 366 port 392 for optical memory two. Flip flop 116 sends a signal via optical channel 255 to signal divider 326 and on to signal divider 346 and on to signal divider 378 and on to signal divider 390. Said signal coming to signal divider 390 goes on to data signal eliminator 396 and on to low pass filter 398 and to optical amplifier 400 to signal divider 386 and light channel 388 to FIG. 7 to go out exit port 416.

Flip flop 116 sends a signal via optical channel 255 to signal divider 326 and on to signal divider 346 and on to signal divider 378 and on to signal divider 390 and on to FIG. 9 via optical channel 404. Flip flop 116 sends a signal from optical channel 223 through signal divider 328 to signal divider 348 to signal divider 380 on to optical channel 402 to FIG. 9.

FIG. 7 shows optical channel 298 leads to signal divider 412 that bring a control signal from flip flop 226 to data signal eliminator 410. Said control signal from flip flop 226 goes on to low pass filter 408 and to optical amplifier 406 to optical channel 324 taking signals from exit port 416 on to FIG. 6. Optical channel 298 leads through signal divider 412 also to signal divider 450 and to data signal eliminator 444 bringing signals from optical channel 338 to low pass filter 446 and to optical amplifier 448. Said signal goes from optical amplifier 448 to signal divider 452 and data signal eliminator 438 and on out to exit port 416 after going through low pass filter 440 and optical amplifier 442.

Flip flop 226 sends a signal to optical channel 302 to signal divider 436 and to data signal eliminator 434 and to low pass filter 432 and optical amplifier 430 to optical channel 358 to send signals to FIG. 6. Flip flop 226 sends a signal to optical channel 302 to signal divider 436 and to signal divider 454 to data signal eliminator 462 admitting signals from optical channel 388. From data signal eliminator 462 the signal goes on to low pass filter 460 and to optical amplifier 464 and to signal divider 452 to go on to exit port 416. Flip flop 226 sends signals through signal dividers 412 and 454 to optical channels 466 and 468 respectively to FIG. 10.

Flip flop 228 sends signals to optical channel 304 and to signal divider 414 to data signal eliminator 428 bringing in signals from exit port 416 through signal divider 418. Said signals from exit port 416 go on to low pass filter 426 and optical amplifier 424 to go no to signal divider 422 to FIG. 6. Flip flop 228 sends signals through optical channel 306 to signal divider 420 to actuate data signal eliminator 438 or go on through optical channel 458 to FIG. 10. Flip flop 228 sends signals to signal divider 414 on to optical channel 456 to FIG. 10.

FIG. 8 shows optical channels 90 and 92 going to FIG. 9, and FIG. 8 shows optical channels 110 and 112 going to FIG. 11. In FIG. 9, a signal comes down from flip flop 116 in FIG. 3 and through FIG. 6 coming through optical channel 402 to signal divider 470 to data signal eliminator 476 to regulate signals from FIG. 10 coming in on optical channel 480 to signal divider 478. Said signal from data signal eliminator 476 to low pass filter 474 to optical amplifier 472 to go to FIG. 8 by way of optical channel 90.

From flip flop 116 a signal comes to optical channel 404 to signal divider 494 and to data signal eliminator 492 and to low pass filter 490 to optical amplifier 488 to go into input/output chip 508 optical channel 510. From FIG. 8 signals come in optical channel 92 to be regulated by data signal eliminator 498. Signals from flip flop 116 through optical channel 402 and signal divider 470 to signal divider 496 to data signal eliminator 498 to regulate said signal from optical channel 92. Said signal goes on to low pass filter 500 to optical amplifier 502 to signal divider 504 to optical channel 482 to FIG. 10.

Flip flop 116 sends a signal through optical channel 404 to signal divider 494 to signal divider 506 to data signal eliminator 514 to bring a signal from input/output 508 from optical channel 512 to low pass filter 516 to optical amplifier 518 to signal divider 504 and optical channel 482 to FIG. 10. Flip flop 116 sends a signal through optical channel 402 to signal divider 470, 496, and 520 to data signal eliminator 532 to regulate signals from optical channel 484 and signal divider 534 through low pass filter 530 and optical amplifier 528 to optical channel 524 in memory chip 522. Flip flop 116 sends a signal through optical channel 404 to signal divider 494 to signal divider 506 and signal divider 542 to data signal eliminator 540 to control signals from FIG. 10 coming through optical channel 484 and signal divider 534. Said signal goes on to low pass filter 538 and optical amplifier 536 to optical channel 546 into memory chip 522.

Flip flop 116 sends a signal through optical channel 402 to signal divider 470, 496, 520, and 544 to data signal eliminator 548 to manage signals coming from optical channel 526 of memory chip 522 going to FIG. 10. Through data signal eliminator 548 the signal goes to low pass filter 552 to optical amplifier 556 to signal divider 558 to optical channel 486 to FIG. 10. Flip flop 116 sends a signal through optical channel 404 to signal divider 494 to signal divider 506 and signal divider 542 and signal divider 564 to data signal eliminator 550. The signal from optical memory chip 522 goes from optical channel 548 through data signal eliminator 550 to low pass filter 560 to optical amplifier 562 to signal divider 558 and optical channel 486 to FIG. 10. Said signal from flip flop 116 goes from signal divider 544 to optical channel 566 and to FIG. 12. Said signal from flip flop 116 goes from signal divider 568 to FIG. 12.

From FIG. 4, flip flop 226 sends signals on optical channels 298 and 302 to FIG. 7 where optical channels 466 and 468 send signals on to FIG. 10. In like manner flip flop 228 sends signals on optical channels 304 and 306 to FIG. 7 where optical channels 456 and 458 send signals on to FIG. 10. Said signal from flip flop 226 on optical channel 466 in FIG. 10 goes to signal divider 590 and to data signal eliminator 592 that regulates signals coming from signal divider 598. Said signal goes from data signal eliminator 592 to low pass filter 596 to optical amplifier 594 to FIG. 9 on optical channel 480.

From flip flop 226 said signal on optical channel 468 goes to signal divider 616 and to data signal eliminator 614. Signal divider 598 sends a signal to be regulated by data signal eliminator 614 that goes on to low pass filter 612 and optical amplifier 610 and to optical channel 484 to FIG. 9. Said signal from signal divider 590 goes on to signal divider 632 and to data signal eliminator 626 which regulates signals from FIG. 9 coming in on optical channel 482. Said signal goes on from data signal eliminator 626 to low pass filter 628 and to optical amplifier 630 to signal divider 634.

Said signal from signal divider 616 continues to signal divider 643 to control data signal eliminator 636 which controls signals coming from optical channel 486 from FIG. 9. Said signal goes through data signal eliminator 636 and on to low pass filter 638 and to optical amplifier 640 to signal divider 634. Said signals from signal divider 632 and 643 go on to optical channels 642 and 644 respectively on to FIG. 13.

Said signal from flip flop 228 on optical channel 456 goes to signal divider 602 and on to data signal eliminator 606 to control data from exit port 609 through signal divider 608. Said data goes on through data signal eliminator 606 to low pass filter 604 and to optical amplifier 600 to signal divider 598. Said signal from flip flop 228 on optical channel 458 goes to signal divider 624 to data signal eliminator 618 that talks signals from signal divider 634 to go to exit port 609. Said signal passing through data signal eliminator 618 to low pass filter 620 and to optical amplifier 622 to go to signal divider 608 and exit port 609. Said signals from signal divider 602 and 624 go on to optical channels 646 and 648 respectively into FIG. 13.

FIG. 11 show optical channels 112 and 110 from FIG. 8 going to FIG. 12. Optical channel 566 brings said signal from flip flop 116 in FIG. 3 in to FIG. 12. Said signal from flip flop 116 goes to signal divider 656 and to data signal eliminator 654 to manage data coming from optical channel 658 through signal divider 660. Data coming through data signal eliminator 654 goes on to low pass filter 652 and optical amplifier 650 to go to FIG. 11 on optical channel 110. Optical channel 568 brings said signal from flip flop 116 that goes to signal divider 668 and data signal eliminator 666 to control data from signal divider 660. Said data from signal divider 660 goes on through data signal eliminator 666 to low pass filter 664 to optical amplifier 662 and to input/output chip 670 in optical channel 679.

Said signal from flip flop 116 in FIG. 3 goes from signal divider 656 to signal divider 676 and to data signal eliminator 672 to regulate data from optical channel 112 from FIG. 11. Said data from optical channel 112 goes through data signal eliminator 672 and on to low pass filter 674 and to optical amplifier 678 to signal divider 680 and optical channel 682 to FIG. 13. Said signal from flip flop 116 in FIG. 3 comes to optical channel 568 and to 668 and to 690 and to data signal eliminator 684. Data from optical channel 681 is managed by data signal eliminator 684 goes on to low pass filter 686 and to optical amplifier 688 to signal divider 680 and optical channel 682 to FIG. 13.

Said signal from flip flop 116 in FIG. 3 goes from signal divider 656 to and 676 to signal divider 698 to data signal eliminator 696 to manage data coming from optical channel 702 and signal divider 700. Said data coming from signal divider 700 goes through data signal eliminator 696 and on to low pass filter 694 and optical amplifier 692 to enter memory chip 712 by optical channel 683. Said signal from flip flop 116 in FIG. 3 from signal divider 668 to signal divider 690 and to signal divider 710 to data signal eliminator 708 to manage data coming from optical channel 702 and signal divider 700. Said data from signal divider 700 goes on through data signal eliminator 708 to low pass filter 706 and to optical amplifier 704 to enter optical memory chip 712 through optical channel 687.

Said signal from signal divider 698 goes to data signal eliminator 714 to manage data from memory chip 712 coming from optical channel 685. Said data from data signal eliminator 714 goes on to low pass filter 716 and optical amplifier 718 to signal divider 720 and optical channel 722 to FIG. 13. Said signal from signal divider 710 goes on to data signal eliminator 724 to manage data from optical memory chip 712 coming from optical channel 689. Said data coming through data signal eliminator 724 goes on to low pass filter 726 to optical amplifier 728 to signal divider 720 and to optical channel 722 to FIG. 13.

Said signal from flip flop 226 in FIG. 4 goes from signal divider 288 in FIG. 4 to signal dividers 412 and 450 in FIG. 7 to signal dividers 590 and 632 in FIG. 10 to optical channel 642 and signal divider 736 to data signal eliminator 734 to manage data coming from signal divider 738. Said data from signal divider 738 goes on from data signal eliminator 734 to low pass filter 732 to optical amplifier 730 to optical channel 658 to FIG. 12. Said signal from flip flop 226 in FIG. 4 goes from signal dividers 268 and 300 in FIG. 4 to signal dividers 436 and 454 in FIG. 7 to signal dividers 616 and 643 in FIG. 10 to optical channel 644 and signal divider 756 to data signal eliminator 754 to manage data coming from signal divider 738. Said data goes on from data signal eliminator 754 to low pass filter 752 to optical amplifier 750 and on to FIG. 12 through optical channel 702.

Said signal from signal divider 736 goes to data signal eliminator 764 to manage data from optical channel 682. Said data from optical channel 682 goes from data signal eliminator 764 to low pass filter 766 to optical amplifier 768 to signal divider 770. Said signal from signal divider 756 goes to data signal eliminator 772 to manage data from optical channel 722. Said data from optical channel 722 goes on from data signal eliminator 772 to low pass filter 774 and to optical amplifier 776 to signal divider 770.

Optical signal from Flip flop 228 in FIG. 4 goes through signal divider 250. In FIG. 7 said signal goes through signal divider 414 to signal divider 602 in FIG. 10 to optical channel 646 in FIG. 13. Said signal from optical channel 646 goes to data signal eliminator 744 to manage data from exit port 748. Said data from exit port 748 goes through data signal eliminator 744 to low pass filter 742 to optical amplifier 740 to signal divider 738.

Flip flop 228 of FIG. 4 sends a signal to the signal divider 266 optical channel 306 to FIG. 7 and on through signal divider 420 to optical channel 458 to FIG. 10 to signal divider 624 optical channel 648 to FIG. 13 to data signal eliminator 758 to manage data from signal divider 770. Said data goes through data signal eliminator 758 on to low pass filter 760 to optical amplifier 762 of signal divider 746 and out of exit port 748.

Data flow and system architecture of the NIBBLE BUS can be seen in FIG. 14A and FIG. 14B. It will be noticed that FIG. 2 is the top left corner of FIG. 14A. It will also be noticed that FIG. 4 is the top right corner of FIG. 14A. It will be noticed that numbered FIG. 11 is the left bottom corner of FIG. 14B. It will also be noticed that numbered FIG. 13 is the right bottom corner of FIG. 14B. The numbered Figures: FIG. 2, FIG. 3, FIG. 4, FIG. 5, FIG. 6, and FIG. 7 are corresponding parts of FIG. 14A. The numbered Figures: FIG. 8, FIG. 9, FIG. 10, FIG. 11, FIG. 12, and FIG. 13 correspond to the parts of FIG. 14 B. The following Figures: FIG. 2, FIG. 3, FIG. 4, FIG. 5, FIG. 6, FIG. 7, FIG. 8, FIG. 9, FIG. 10, FIG. 11, FIG. 12, and FIG. 13 and their numbered parts have been discussed in detail in paragraphs [0012] to [0057]. One can trace the signals spoken of in the detailed description of paragraphs [0012] through [0057] on FIG. 14A and FIG. 14B. FIG. 14A and FIG. 14B are an overview of the NIBBLE BUS light channels and optical devices that comprise it. The drawings provided in this disclosure are schematic only and actual equipment will have other features that are not necessary for the understanding of the NIBBLE BUS invention.

We claim as our invention:

1. An all-optical signal broker comprised of a receive and transmit flip-flop fed by a receive data line and a transmit data line, a memory broker flip-flop fed by a memory one and a memory two data control lens, an input/output or memory broker flip-flop fed by an input-output and memory input control data lines, a listen for input signal or central processing unit flip-flop fed by a listen data line and a central processing unit data control lines, and a clock data control line that feeds all four said flip-flops with a timing signal, said input/output chip managing signals, these four said flip-flops controlling optical channels that broker the output signals from said central processing unit which is fed by four input signal channels directing data into and out of said memory chip to output lines feeding another optical computer system or optical communication system.

2. An all-optical signal broker as claimed in claim 1 which uses control signals that are twice the frequency of the data signals.

3. In an alternative embodiment, an all-optical signal broker is claimed as is claimed in claim 1 in which several NIBBLE BUS assemblies may be grouped together with other NIBBLE BUS assemblies to control 8, 16, 32, 64 or more input signals.

4. In an alternative embodiment, an all-optical signal broker as is claimed in claim 1 with which one, two, or three input channels are managed by the NIBBLE BUS.

5. In an alternative embodiment, an all-optical signal broker as is claimed in claim 1 with which any number of input channels can be managed combining NIBBLE BUS assemblies that manage any number of input channels such as 5, 6, 7, or any other number of input channels.

6. An all-optical signal controller receiving four optical or electronic input signals into a central processing unit the out put of which is managed by a flip-flop that controls whether the central processing unit listens to the input or sends optical signals out to an other computer system or an optical communication system, a flip-flop that controls whether signals go to memory or input/output chip, a flip-flop that controls whether signals are stored in a first or a second memory, a flip-flop that controls whether the NIBBLE BUS receives or transmits optical signals to an-other computer system or to an optical communication system

7. An all-optical method of managing signals from a computer system or optical communication system to a other computer system or optical communication system.

8. In an alternative embodiment, an all-optical signal controller is claimed as is claimed in claim 6 which can be grouped together with other NIBBLE BUS controllers to control 8, 16, 32, 64 or more input signals.

9. In an alternative embodiment, an all-optical signal controller as is claimed in claim 6 with which one, two, or three input channels are managed by the NIBBLE BUS.

10. In an alternative embodiment, an all-optical signal controller as is claimed in claim 6 with which any number of input channels can be managed grouping several NIBBLE BUS assemblies that manage any number of input channels such as 5, 6, 7, or any other number of input channels.

11. An all-optical signal controller as claimed in claim 6 which uses control signals that are twice the frequency of the data signals.
